(19) United States
(12) Patent Application Publication
(10) Pub. No.: US 2014/0240093 A1
(43) Pub. Date: Aug. 28, 2014

(54) NONE-POWER STATE INDICATION APPARATUS

(71) Applicant: IRICE ENERGY TECHNOLOGY(SHENZHEN) CO., LTD., Shen Zhen (CN)

(72) Inventors: SHIH-HUI CHEN, Taoyuan Hsieh (TW); CHIN- TIEN LIN, Taoyuan Hseih (TW)

(73) Assignee: IRICE ENERGY TECHNOLOGY(SHENZHEN) CO., LTD., Shen Zhen (CN)

(21) Appl. No.: 13/778,338

(22) Filed: Feb. 27, 2013

(51) Int. Cl. G08B 5/36

(52) U.S. Cl. CPC G08B 5/36
USPC 340/6.1

(57) ABSTRACT

A none-power state indication apparatus includes an optoelectronic device electrically connected to a power supply circuit of an electric product, and generating a predetermined light color under power effect of the power supply circuit; a case member for covering an upper portion of the optoelectronic device, wherein a display zone corresponding to the optoelectronic device and differing from a color of a case surface of the case member. Under a state of supplying power to the electric product, the color of the display zone of the case member generates change state that is identical to the color of the case surface due to light source effect of the optoelectronic device. On the other hand, under a state of supplying no power to the electric product, the obvious display zone appears on the case surface due to lost light source of the optoelectronic device, thereby indicating the none-power state.

### BACKGROUND OF THE INVENTION

1. Field of the Invention

The invention relates to a power supply indication apparatus of electric products, and more particularly to a none-power state indication apparatus capable of utilizing relatively obvious form to show the electric products at none-power state under a condition of supplying no power to the electric products, thereby preventing users from error determining.

2. Description of the Related Art

In modern society, electric products have become necessary equipment in daily life. Since technology is continuously advanced, much equipment is electrified and further electrized (or digitalized) to relatively enhance usage convenience and feeling.

Moreover, when electric equipment is gradually popularized, consumers may have various options in purchasing the foregoing equipment. Each company develops new products. Not only the quality and inexpensive price of these products are increased, but also specific functions and multifunction are provided to these products to attract consumers so as to enhance market competition.

For example, the majority of home appliances is added with remote control function. With the attached remote control, a user may press keys on the remote control to allow the home appliances to operate upon predetermined modes to increase convenience when he/she is distant from the home appliances.

The majority of electric products (especially for the foregoing home appliances having remote control function) are in standby state under non-using condition and not in service interruption state. Consequently, the product state may be easily error-determined by the user. In case of any related cleaning, moving or repairing, internal components of the products may be damaged, or electric shock may occur.

Furthermore, some electric products would further dispose a power state indicator, which is similar to conventional power state indicators, on the machine body. The electric product is in use or non-use condition by principally changing colors. Alternatively, the electric product shows predetermined light color to achieve the purpose of state indication when the product is under non-using condition.

However, the foregoing conventional power state indicator may not generate light source when the electric product is in a state of completely interrupting service. With respect to whole electric product, a system of adequately showing that the product is actually in service interruption state is unable to be provided as well. The user might still make error determination regarding the state of the product.

### SUMMARY OF THE INVENTION

Therefore, it is an objective of the present invention to provide a none-power state indication apparatus capable of showing an electric product that is at none-power state through relatively obvious form so as to prevent a user from error determining.

To achieve the foregoing objective, the none-power state indication apparatus of the invention comprises an optoelectronic device electrically connected to a power supply circuit of an electric product and generating predetermined light color under a power effect of the power supply circuit; a case member for covering an upper portion of the optoelectronic device, a display zone corresponding to the optoelectronic device and differing from a color of a case surface of the case member disposed to the case surface.

By utilizing the foregoing structures, the none-power state indication apparatus of the invention allows color of the display zone of the case member to generate change state that is identical to color of a case surface due to light source effect of the optoelectronic device under a state of supplying power to the electric product, thereby achieving a visual effect of hiding the display zone of the case surface. Therefore, the case surface of the case member shows single color and shape. On the other hand, under a state of supplying no power to the electric product, the display zone appears on the case surface of the case member due to lost light source of the optoelectronic device, thereby achieving the purpose of indicating none-power state.

The none-power state indication apparatus of the invention can provide the following advantages: 1. Under the state of supplying no power to the applied electric product, the electric product is indicated by relatively aggressive means to be at the none-power state; 2. An indication effect is provided under a state of no electrifying the optoelectronic device. When the applied electric product is not in use, the optoelectronic device is additionally supplied with power to further save power and energy; 3. It can be further applied to a backup power or the movable power. When the power stored in the backup power or the movable power is exhausted, the purpose of indicating the backup power or the movable power at none-power state can be achieved.

### BRIEF DESCRIPTION OF THE DRAWINGS

The detailed structure, operating principle and effects of the present invention will now be described in more details hereinafter with reference to the accompanying drawings that show various embodiments of the invention as follows.

FIG. 1 is an appearance structure diagram of the a none-power state indication apparatus according to a first embodiment of the invention;

FIG. 2 is a structural decomposition diagram of a none-power state indication apparatus according to a first embodiment of the invention;

FIG. 3 is a usage configuration diagram of a none-power state indication apparatus according to a second embodiment of the invention;

FIG. 4 is a usage configuration diagram of a none-power state indication apparatus according to a third embodiment of the invention;

FIG. 5 is an appearance planar diagram of a none-power state indication apparatus according to a fourth embodiment of the invention;

FIG. 6 is an appearance planar diagram of a none-power state indication apparatus according to a fifth embodiment of the invention;

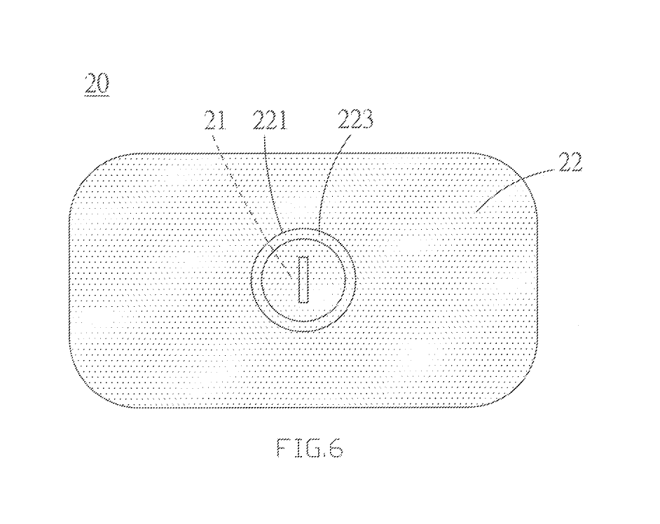

FIG. 7 is an appearance structure diagram of a none-power state indication apparatus integrated into a simplified mobile phone according to the invention;

FIG. 8 is a block diagram of composition architecture of a none-power state indication apparatus integrated into a simplified mobile phone according to the invention;

FIG. 9 is an appearance structure diagram of a none-power state indication apparatus integrated into a rechargeable battery according to the invention;

FIG. 10 is a block diagram of composition architecture of a none-power state indication apparatus integrated into a rechargeable battery according to the invention;

FIG. 11 is an appearance structure diagram of a none-power state indication apparatus integrated into a movable power according to the invention;

FIG. 12 is a block diagram of composition architecture of a none-power state indication apparatus integrated into a movable power according to the invention.

### DETAILED DESCRIPTION OF THE PREFERRED EMBODIMENTS

The technical content of the present invention will become apparent by the detailed description of the following embodiments and the illustration of related drawings as follows.

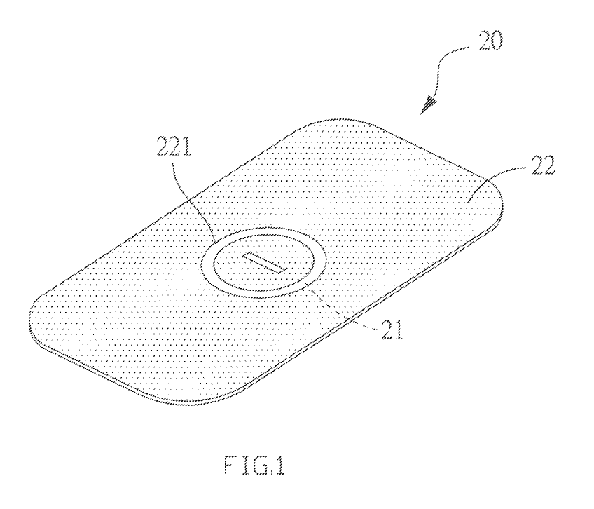

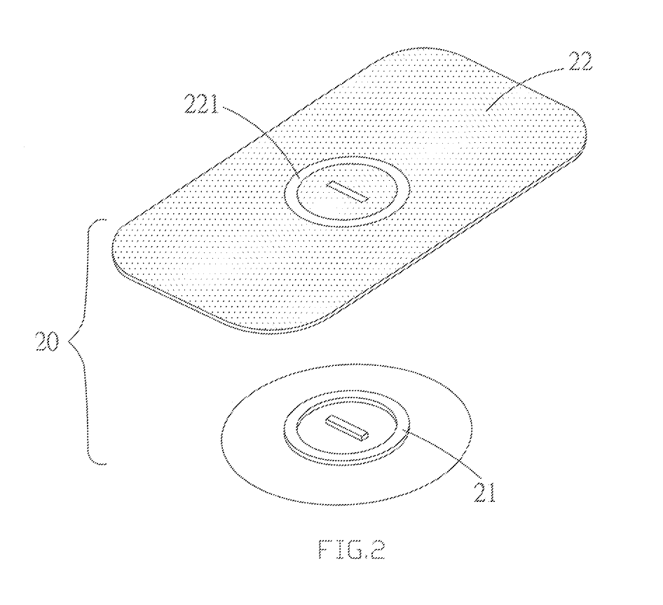

As shown in FIG. 1 and FIG. 2 for an appearance structural diagram of a none-power state indication apparatus according to a first embodiment of the invention and a structural decomposition diagram of a none-power state indication apparatus according to a first embodiment of the invention are depicted. The none-power state indication apparatus 20 of the invention basically includes as the following.

An optoelectronic device 21 is electrically connected to a power supply circuit of the electric product and generates a predetermined light color under the electrostatic effect of the power supply circuit.

A case member 22 covers an upper place of the optoelectronic device 21, wherein its case surface is disposed with a display zone 221 corresponding to the optoelectronic device 21 and that differs from the color of the case surface of the case member 22.

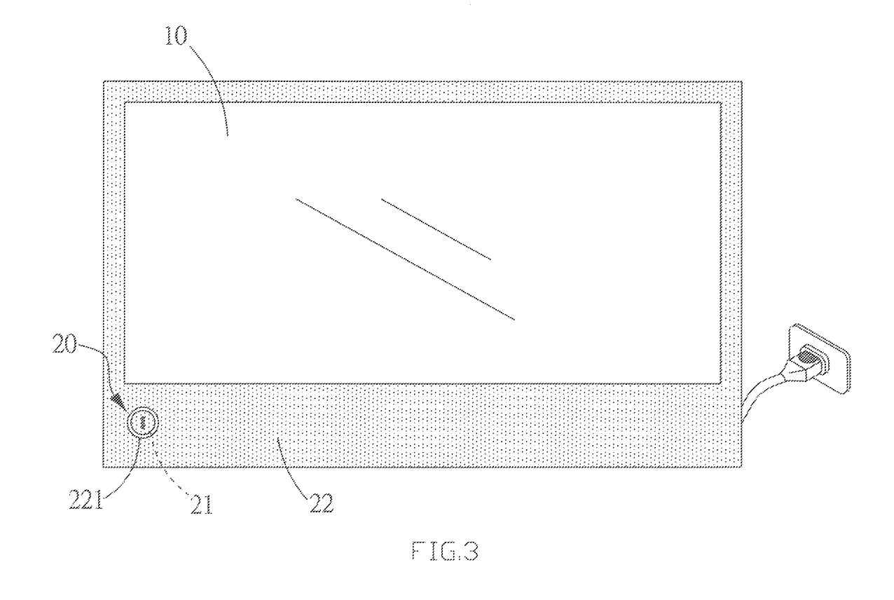

Principally, the none-power state indication apparatus of the invention can be widely applied to all electric products (i.e. TVs, acoustics, video players, computers and other small appliances) that require power for operation. With reference to FIG. 3, when the none-power state indication apparatus 20 of the invention is in use, the apparatus can be mounted to a housing of the electric product 10 (as shown in the TV), and the optoelectronic device 21 is electrically connected to the power supply circuit of the electric product 10.

Under the state of supplying power to the electric product 10, since the optoelectronic device 21 generates light source having predetermined light color, color of the display zone 221 of the case member 22 may have state change that is identical to the color of the case surface of the case member 22 under light source effect of the optoelectronic device 21. Therefore, the visual effect of hiding the display zone 221 of the case surface can be achieved to allow the case surface of the case member 22 to show single color and shape. On the other hand, when the electric product 10 is at the none-power state as no power supply, the obvious display zone 221 appears on the case surface of the case member 22 due to lost light source effect of the optoelectronic device 21, thereby achieving the purpose of indicating none-power state.

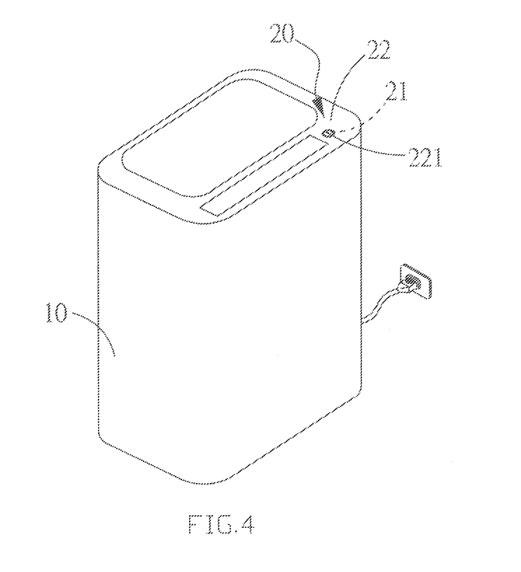

In the embodiment shown in FIG. 3, the case member 22 is designed by directly integrating it with the housing of the electric product 10. Of course, it can also be shown in FIG. 4, the case member 22 is designed by integrating an operating panel of the electric product 10 or further designed as a component type attached to the power line of the electric product so as to match the mounting demand of different subjects.

Moreover, in the foregoing component shown in FIG. 1 and FIG. 2, the display zone 221 of the case member 22 is composed of a light transmittance portion having predetermined shape (the light transmittance portion can be predetermined patterns or symbols). The optoelectronic device 21 generates light color identical to the color of the case surface of the case member 22 under power supply state such that the optoelectronic device 21 generates light source that is identical to the color of the case surface of the case member 22 to allow the color of the display zone of the case member generates identical color as well as the color of the case surface, thereby achieving a visual effect of hiding the display zone of the case surface. On the other hand, under none-power state as no power supply, the obvious display zone 221 appears on the case surface of the case member 22 due to lost light source effect of the optoelectronic device 21, thereby achieving the purpose of indicating none-power state.

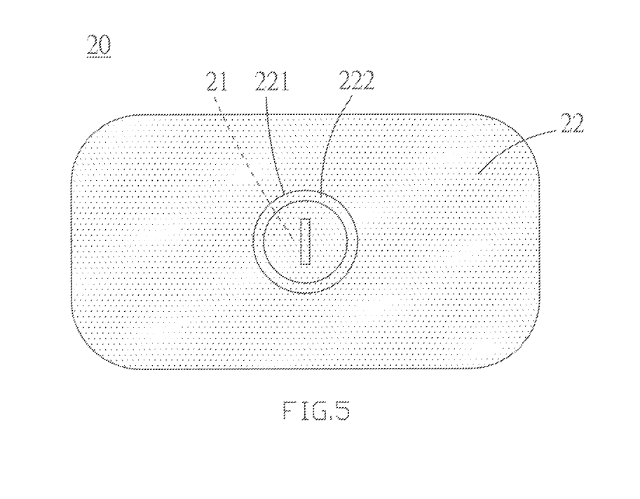

As shown in FIG. 5, the display zone 221 of the case member 22 can also be mixed with a light-sensitive material 222 capable of taking light color effect of the optoelectronic device to show a color that is identical to the color of the case surface of the case member 22 such that the display zone 221 shows the effect that differs from the color of the case surface of the case member 22 under a normal condition (at a state of supplying no power). While supplying power, the display zone 221 is changed with color that is identical to the case surface of the case member 22 since the light-sensitive material 222 takes light source effect of the optoelectronic device 21. Therefore, the effect of hiding the display zone 221 can be achieved. On the other hand, while supplying no power, the color that differs from the case surface of the case member 22 can be shown.

Of course, the display zone 221 of the case member 22 mixed with the light-sensitive material 222 can also be replaced with a temperature sensing material 223 capable of being affected by the temperature effect of the optoelectronic device 21 showing the color that is identical to the color of the case surface of the case member 22 (In another word, the display zone 221 of the case member 22 shown in FIG. 5 is mixed with the light-sensitive material 222 capable of being affected by a light color effect of the optoelectronic device 21 showing the color that is identical to the color of the case surface of the case material 21). While supplying power, the display zone 221 is changed with color that is identical to the color of the case surface of the case member 22 due to the temperature sensing material 223 affected by the temperature effect of the optoelectronic device 21, thereby achieving the effect of hiding the display zone 221. On the other hand, while supplying no power, it shows color that differs from the case surface of the case member 22.

It should be noted that the none-power state indication apparatus of the invention is applied to all electric products driven by power at the implementation state to electrically connect electrical components with the power supply circuit of a power input side of the electric product. Of course, the none-power state indication apparatus of the invention can also be applied to all hand-held devices operated by battery power to display the power state of its battery and can be further integrated into a finished product of the hand-held device.

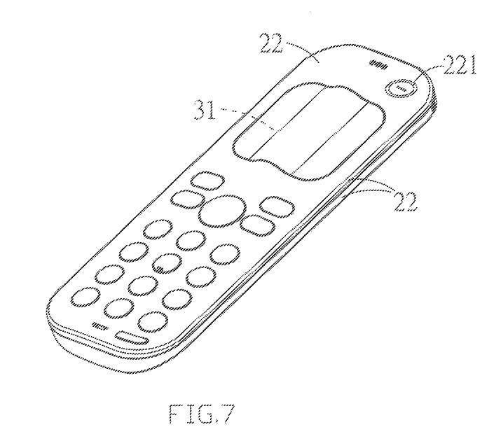

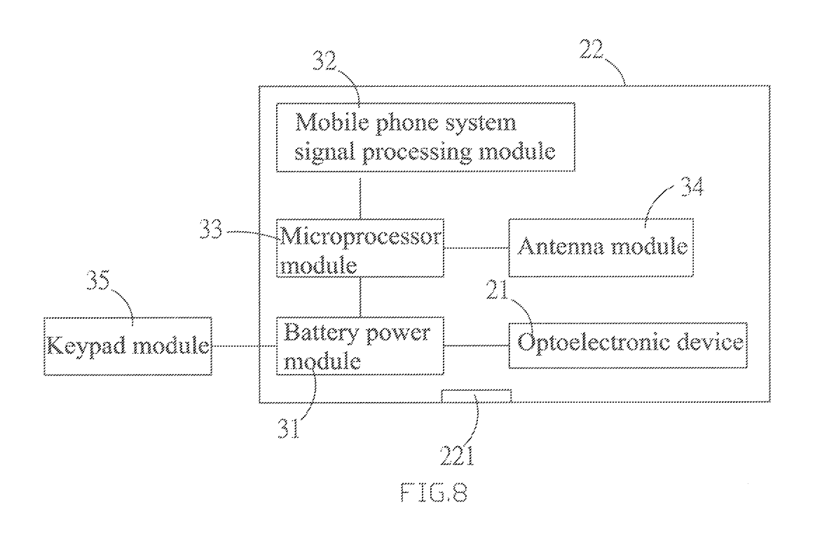

For example, in the embodiment shown in FIG. 7 and FIG. 8, the case member 22 of the none-power state indication apparatus of the invention can be a simplified mobile phone case shown in the figure, and a battery power module 31 for installing batteries, a mobile phone system signal processing module 32, a microprocessor module 33 and an antenna module 34 are electrically integrated into the case member 22. The optoelectronic device 21 is electrically connected to the battery power module 31, and the case member 22 is disposed with a keypad module 31 electrically connected to the microprocessor module 33. A simplified mobile phone having lower manufacture costs, relatively simplified operating way and convenience can be obtained, and the user is further reminded by aggressive means to replace batteries or not.

The none-power state indication apparatus of the invention can be further integrated into the electric product taken for power output purpose such as a rechargeable battery of a mobile digital device or a movable power.

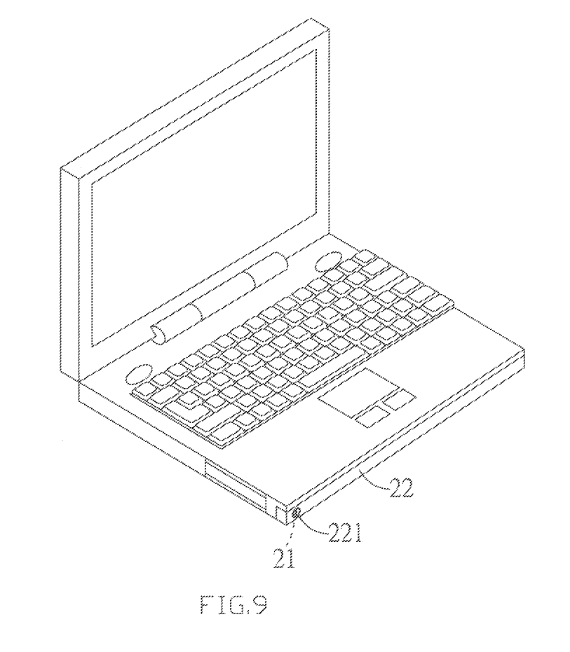

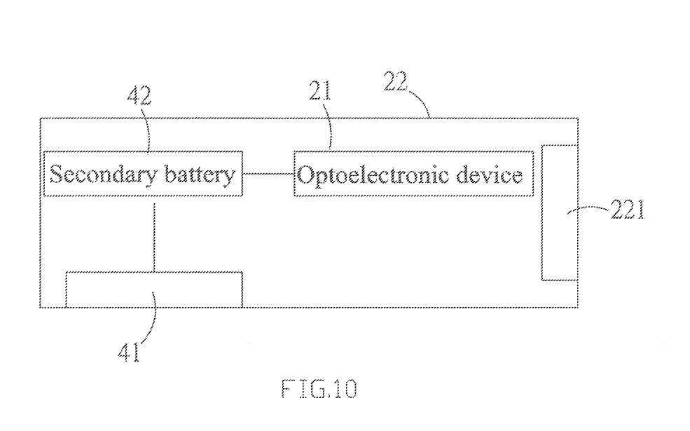

Under the implementation state of integrating the none-power state indication apparatus of the invention into the rechargeable battery of the mobile digital device, as shown in FIG. 9 and FIG. 10, the case member 22 can be a case disposed with an electrode contact 41, and at least a secondary battery 42 electrically connected to the electrode contact 41 is disposed inside the case member 22. The optoelectronic device 21 is electrically connected to the secondary battery 42 to obtain a rechargeable battery installed to a mobile digital device (a laptop computer shown in the figure), and the rechargeable battery is indicated by aggressive means to be at the none-power state when the stored power inside the secondary battery 42 is exhausted.

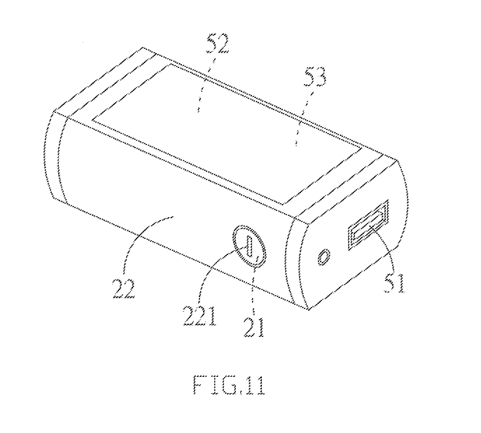

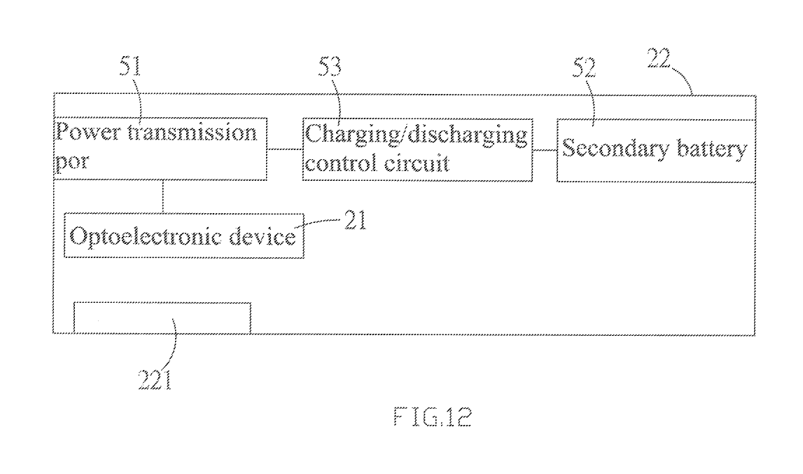

Under the implementation state of integrating the none-power state indication apparatus of the invention into the movable power, as shown in FIG. 11 and FIG. 12, the case member 22 can be a case disposed with a power transmission port 51, and at least a secondary battery 52 electrically connected to the power transmission port 51 is disposed inside the case member 22. A charging/discharging control circuit 53 is electrically connected between the power transmission port 51 and the secondary battery 52. The optoelectronic device 21 is electrically connected to the secondary battery 52 to obtain a portable movable power, and the movable power is indicated by relatively aggressive means to be at the none-power state when the stored power inside the secondary battery 52 is exhausted.

By comparing with the conventional structure, the none-power state indication apparatus of the invention can provide the following advantages: 1. Under the state of supplying no power to the applied electric product, the electric product is indicated by relatively aggressive means to be at the none-power state; 2. An indication effect is provided under a state of no electrifying the optoelectronic device. When the applied electric product is not in use, the optoelectronic device is additionally supplied with power to further save power and energy; 3. It can be further applied to a backup power or the movable power. When the power stored in the backup power or the movable power is exhausted, the purpose of indicating the backup power or the movable power at none-power state can be achieved.

While the means of specific embodiments in a none-power state indication apparatus of the present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A none-power state indication apparatus comprising:
an optoelectronic device electrically connected to a power supply circuit of an electric product and generating predetermined light color under a power effect of the power supply circuit;
a case member for covering an upper portion of the optoelectronic device, a display zone corresponding to the optoelectronic device and differing from a color of a case surface of the case member disposed to the case surface.

2. The none-power state indication apparatus of claim 1, wherein the display zone of the case member is composed of a light transmittance portion having a predetermined shape, and the optoelectronic device generates a light color that is identical to a color of the case surface of the case member under power supply state.

3. The none-power state indication apparatus of claim 1, wherein the display zone of the case member is mixed with a light-sensitive material capable of taking the light color effect of the optoelectronic device to show a color that is identical to the color of the case surface of the case member.

4. The none-power state indication apparatus of claim 1, wherein the display zone of the case member is mixed with a temperature sensing material capable of taking the temperature effect of the optoelectronic device to show a color that is identical to the color of the case surface of the case member.

5. The none-power state indication apparatus of claim 1, wherein the case member is a simplified mobile phone case, and a battery power module for installing batteries, a mobile phone system signal processing module, a microprocessor module and an antenna module are electrically integrated inside the case member, and the optoelectronic device is electrically connected to the battery power module, and a keypad module electrically connected to the microprocessor module is disposed to the case member.

6. The none-power state indication apparatus of claim 1, wherein the case member is a case disposed with an electrode contact, and at least a secondary battery electrically connected to the electrode contact is disposed inside the case member, and the optoelectronic device is electrically connected to the secondary battery.

7. The none-power state indication apparatus of claim 1, wherein the case member is a case disposed with a power transmission port, and at least a secondary battery electrically connected to the power transmission port is disposed inside the case member, and a charging/discharging control circuit is electrically connected between the power transmission port and the secondary battery, and the optoelectronic device is electrically connected to the secondary battery.
